(19) United States
(12) Patent Application Publication
(10) Pub. No.: US 2020/0247231 A1
(43) Pub. Date: Aug. 6, 2020

(54) VEHICLE COOLING DEVICE

(71) Applicant: AISIN SEIKI KABUSHIKI KAISHA, Kariya-shi (JP)

(72) Inventors: Hiroki TANAKA, Kariya-shi (JP); Tomoki MITSUYA, Kariya-shi (JP); Yusuke HIBINO, Kariya-shi (JP)

(73) Assignee: AISIN SEIKI KABUSHIKI KAISHA, Kariya-shi (JP)

(21) Appl. No.: 16/774,485

(22) Filed: Jan. 28, 2020

(30) Foreign Application Priority Data
Jan. 31, 2019 (JP) 2019-015042

(51) Int. Cl. B60K 11/08

(52) U.S. Cl. CPC B60K 11/085; B60R 19/44

(57) ABSTRACT

A vehicle cooling device includes a heat exchanger, an under cover, and a rear duct. The heat exchanger is arranged so as to be exposed to outside air that is taken into an inside of a vehicle from a front side of the vehicle and that flows backward. The under cover constitutes a lower wall surface of a front end portion of the vehicle. The under cover includes a front cover portion and a rear cover portion that can open and close an opening portion positioned on a rear side of the heat exchanger, and an actuator that drives opening and closing of the front cover portion and the rear cover portion. The rear duct is provided on a rear side of the heat exchanger, and guides, to the opening portion of the under cover, outside air that passes through the heat exchanger.

### CROSS REFERENCE TO RELATED APPLICATIONS

This application is based on and claims priority under 35 U.S.C. § 119 to Japanese Patent Application No. 2019-015042, filed on Jan. 31, 2019, the entire content of which is incorporated herein by reference.

### TECHNICAL FIELD

This disclosure relates to a vehicle cooling device.

### BACKGROUND DISCUSSION

As described in JP 2003-72394 A (Reference 1), a vehicle cooling device is known. The vehicle cooling device is provided at a front end portion (an engine room) of a vehicle. The vehicle cooling device includes a heat exchanger, an under cover, and a wind direction adjuster. The heat exchanger causes heat exchange between cooling water for an engine and outside air. The under cover constitutes a lower wall surface of the front end portion of the vehicle, and prevents foreign objects (e.g., pebbles jumped up from a road surface) from colliding with the engine, the heat exchanger, and the like from below a vehicle body while the vehicle is running. A substantially rectangular opening portion that extends in a vehicle width direction is provided at a part that is in the under cover and that is positioned on a rear side of the heat exchanger. The under cover includes a cover portion that can open and close the opening portion. The cover portion is a substantially rectangular plate-shaped member extending in the vehicle width direction. A front edge portion (a long-side portion) of the cover portion is rotatably supported by a shaft member extending in the vehicle width direction. When the vehicle is stopped or running at a low speed, the cover portion is in an opened state due to the own weight. The wind direction adjuster is provided on a rear surface of the heat exchanger. The wind direction adjuster includes a plurality of thin plate-shaped vanes extending in the vehicle width direction. These vanes are arranged at a predetermined interval in a vehicle height direction. A thickness direction of each of the vanes is inclined from a vehicle front-rear direction. Specifically, in each of the vanes, a lower side thereof is positioned on a rear side of an upper side thereof. A gap is provided between two vanes adjacent to each other in the vertical direction, and outside air can flow through the gap. The outside air that has been taken into an inside of the front edge portion (an engine room) of the vehicle and has passed through the heat exchanger hits the vanes and passes through the gaps between the vanes. Thereby, a wind direction of the outside air is changed to backward and downward. Note that an inclination angle of each of the vanes is set in such a way that the outside air that has passed through the heat exchanger flows toward the opening portion of the under cover.

In the above-described conventional vehicle cooling device, the cover portion of the under cover is open at the time of warm-up operation immediately after the engine is started and at the time that the vehicle is stopped or is running at a low speed. Accordingly, outside air easily flows through the heat exchanger. For this reason, there is a possibility that efficiency of the warm-up operation is reduced.

A need thus exists for a vehicle cooling device which is not susceptible to the drawback mentioned above.

### SUMMARY

A vehicle cooling device according to this disclosure includes a heat exchanger, an under cover, and a rear duct. The heat exchanger is arranged so as to be exposed to outside air that is taken into an inside of a vehicle from a front side of the vehicle and that flows backward. The under cover constitutes a lower wall surface of a front end portion of the vehicle. The under cover includes a cover portion that can open and close an opening portion positioned on a rear side of the heat exchanger, and a driving device that drives opening and closing of the cover portion. The rear duct is provided on a rear side of the heat exchanger, and guides, to the opening portion of the under cover, outside air that passes through the heat exchanger.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view illustrating a structure of a front portion of a vehicle to which a vehicle cooling device according to this disclosure has been applied;

FIG. 2 is a side view of viewing the vehicle cooling device in FIG. 1 from a left side;

FIG. 3 is a front view of viewing the vehicle cooling device in FIG. 1 from a front side;

FIG. 4A is an exploded perspective view when the cooling device vehicle in FIG. 1 is disassembled and is viewed obliquely from a front side;

FIG. 4B is an exploded perspective view when the cooling device vehicle in FIG. 1 is disassembled and is viewed obliquely from a rear side;

FIG. 5A is a left side view of an opening-closing device in a state of closing an opening portion of an under cover;

FIG. 5B is a left side view of the opening-closing device in a state of opening the opening portion of the under cover;

FIG. 6 is a perspective view of viewing a front duct obliquely from a front side;

FIG. 7A is a cross-sectional view of a center portion of the vehicle cooling device in a vehicle width direction in a state where opening portions of the under cover and a grill shutter are closed; and

FIG. 7B is a cross-sectional view of the center portion of the vehicle cooling device in the vehicle width direction in a state where the opening portions of the under cover and the grill shutter are opened.

### DETAILED DESCRIPTION

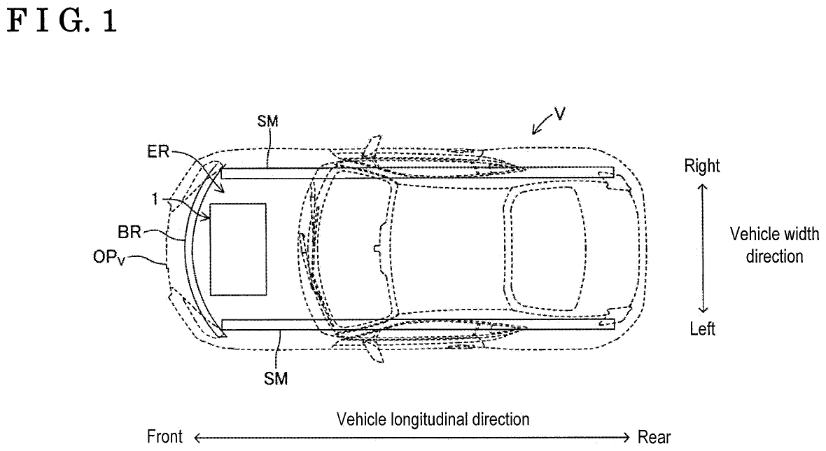

Hereinafter, a vehicle cooling device 1 according to one embodiment of this disclosure is described. First, a structure of a front end portion of a vehicle V to which the vehicle cooling device 1 has been applied is briefly described. As illustrated in FIG. 1, the vehicle includes a pair of left and right side members SM and SM extending in a vehicle front-rear direction. A bumper reinforcement BR extending in a vehicle width direction is attached to front end surfaces of the side members SM and SM. The vehicle cooling device 1 is arranged in a space (an engine room ER) surrounded by the bumper reinforcement BR and the side members SM and SM. An opening portion OPv is provided in a front end surface of the vehicle V, and outside air is taken into the engine room ER from the opening portion OPv.

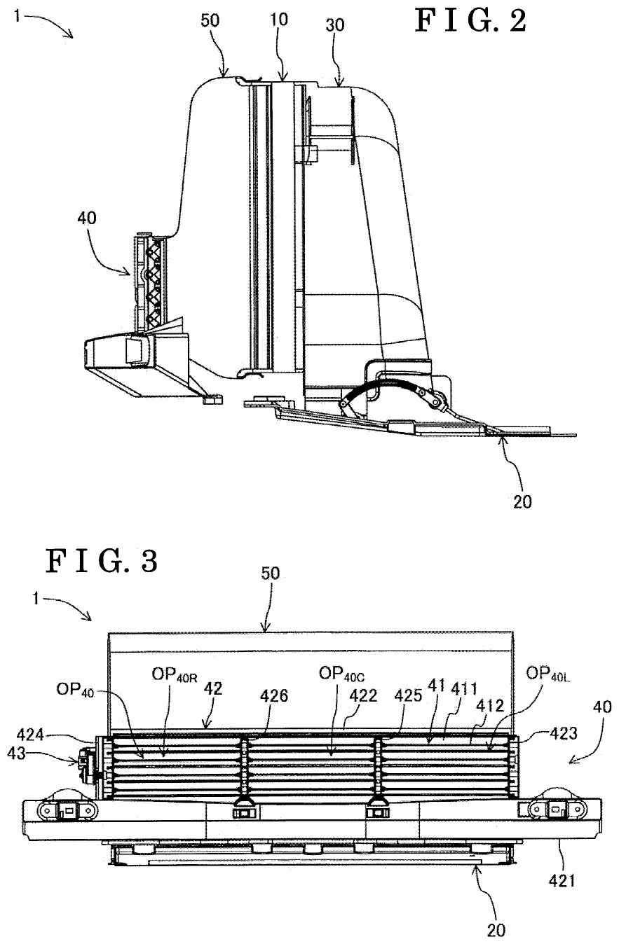

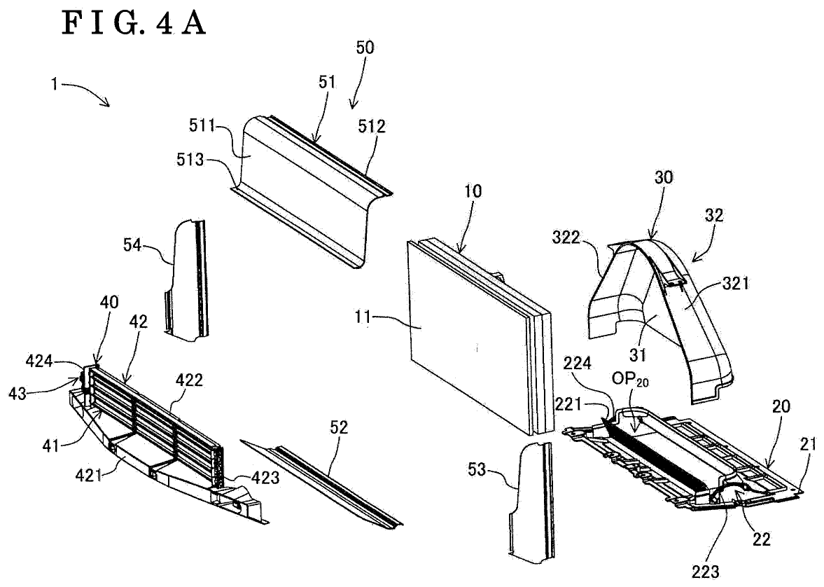

Next, a configuration of the vehicle cooling device 1 is specifically described. As illustrated in FIG. 2 and FIG. 3, the vehicle cooling device 1 includes a heat exchanger 10, an under cover 20, a rear duct 30, a grille shutter 40, and a front duct 50.

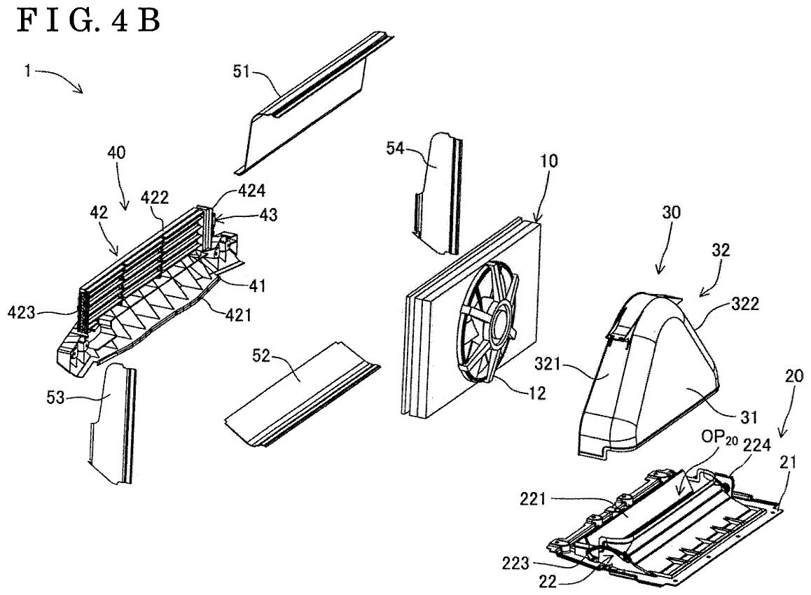

A structure of the heat exchanger 10 is similar to that of a known heat exchanger. In other words, the heat exchanger 10 is connected to a cooling-water flow path provided in an engine, and cools cooling water that has passed through the engine and thereby become high in a temperature. The heat exchanger 10 includes a plurality of fins 11 in each of which a cooling-water flow path is provided (refer to FIG. 4A and FIG. 4B). A cooling fan 12 is provided on a rear side of a plurality of the fins 11. The cooling fan 12 causes outside air to flow from a front side of the fins 11 to a rear side of the fins 11. The fins 11 dissipates heat of cooling water flowing through the flow paths provided therein. In other words, the fins 11 cause heat exchange between the cooling water and the outside air. Note that the heat exchanger 10 is fixed to a frame of the vehicle V via an un-illustrated bracket.

The under cover 20 includes a plate-shaped body portion 21 that is substantially perpendicular to a vehicle height direction. The body portion 21 constitutes a lower wall surface of the engine room ER. The body portion 21 prevents foreign objects (e.g., jumped-up pebbles) from colliding with devices (the engine, the heat exchanger 10, and the like) in the engine room ER from below the engine room ER. A plurality of reinforcement ribs and bosses and the like are formed in an upper surface of the body portion 21.

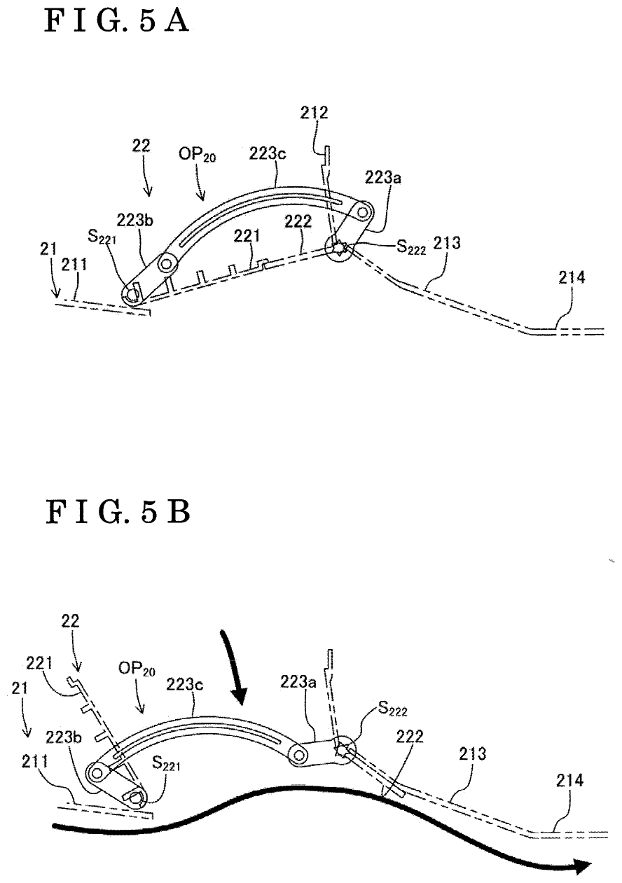

An opening portion OP₂₀ extending in the vehicle width direction is formed at a front end portion (a part positioned on a rear side of the heat exchanger 10) of the body portion 21. In a plan view of the under cover 20, the opening portion OP₂₀ has a rectangular shape extending in the vehicle width direction. As illustrated in FIG. 5A and FIG. 5B, a peripheral portion that is in the body portion 21 and that is on a front side of the opening portion OP₂₀ is constituted of a horizontal wall portion 211 that is substantially perpendicular to the vehicle height direction. Further, as illustrated in the same figures, a peripheral portion that is in the body portion 21 and that is on a rear side of the opening portion OP₂₀ is constituted of a vertical wall portion 212 perpendicular to the vehicle front-rear direction, an inclination wall portion 213 extending downward and rearward from a lower end of the vertical wall portion 212, and a horizontal wall portion 214 extending rearward from a lower end (a rear end) of the inclination wall portion 213 and substantially perpendicular to the vehicle height direction. The horizontal wall portion 211 and the horizontal wall portion 214 have the substantially same height.

Further, the under cover 20 includes an opening-closing device 22 that opens and closes the opening portion OP₂₀. The opening-closing device 22 includes a front cover portion 221, a rear cover portion 222, a pair of left and right link mechanisms 223 and 223, and an actuator 224 (refer to FIG. 4A and FIG. 4B). Each of the front cover portion 221 and the rear cover portion 222 is a substantially rectangular plate-shaped member that extends in the vehicle width direction. A shaft portion S₂₂₁ extending in the vehicle width direction is formed at a front end portion of the front cover portion 221. The shaft portion S₂₂₁ is supported by a shaft support portion provided in an upper surface of the horizontal wall portion 211. As described in detail below, the front cover portion 221 is opened and closed by rotating the shaft portion S₂₂₁ around a central axis thereof. Further, a shaft portion S₂₂₂ extending in the vehicle width direction is formed at a rear end portion of the rear cover portion 222. The shaft portion S₂₂₂ is supported by a shaft support portion provided at a front end (an upper end) of the inclination wall portion 213. As described in detail below, the rear cover portion 222 is opened and closed by rotating the shaft portion S₂₂₂ around a central axis thereof. Note that FIG. 5A and FIG. 5B illustrate the left link mechanism 223. The actuator 224 is assembled to the right link mechanism 223.

The link mechanisms 223 and 223 are arranged on the left and right sides of the opening portion OP₂₀, respectively. The link mechanism 223 is constituted of a first arm 223a, a second arm 223b, and a third arm 223c. The first arm 223a, the second arm 223b, and the third arm 223c are plate-shaped long members perpendicular to a left-right direction. The first arm 223a and the second arm 223b extend straight, whereas the third arm 223c is curved in an arcuate shape. One end portion of the first arm 223a in a longitudinal direction thereof is supported so as to be rotatable around the shaft portion S₂₂₂. One end portion of the second arm 223b in a longitudinal direction thereof is supported so as to be rotatable around the shaft S₂₂₁. The other end portion of the first arm 223a in the longitudinal direction and one end portion of the third arm 223c in a longitudinal direction thereof are rotatably connected to each other, and the other end portion of the third arm 223c in the longitudinal direction and the other end portion of the second arm 223b in the longitudinal direction are rotatably connected to each other. Note that the third arm 223c is curved as described above, and the third arm 223c is connected to the first arm 223a and the second arm 223b in such a way that an intermediate portion of the third arm 223c in the longitudinal direction is positioned (in an upward convex shape) on an upper side of the end portions thereof. The first arm 223a and the second arm 223b are fixed to the shaft portion S₂₂₁ and the shaft portion S₂₂₂, respectively.

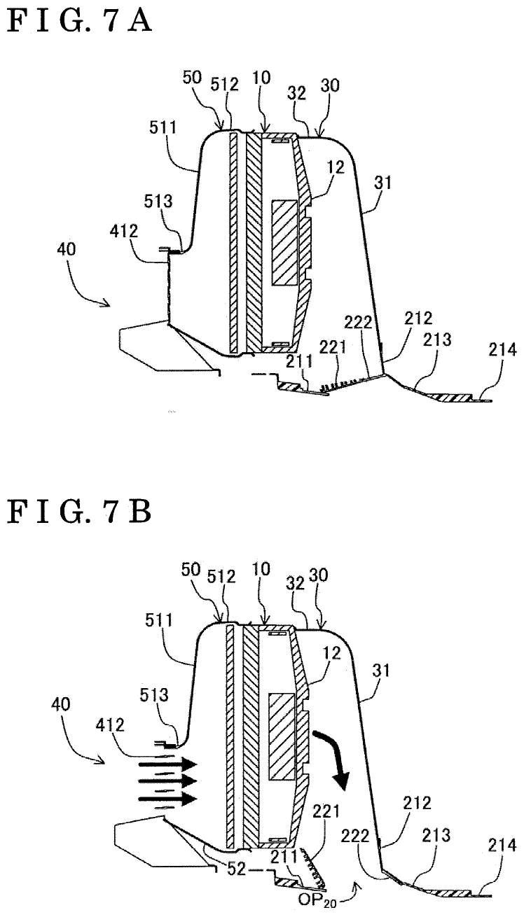

From a state where the opening portion OP₂₀ is closed by the front cover portion 221 and the rear cover portion 222 (refer to FIG. 5A), the actuator 224 rotates the shaft portion S₂₂₂ counterclockwise in the same figure. At this time, rotational driving force of the actuator 224 is transmitted to the shaft portion S₂₂₁ via the link mechanisms 223 and 223, and the shaft portion S₂₂₁ is also rotated counterclockwise in the same figure. Thereby, the front cover portion 221 and the rear cover portion 222 rotate counterclockwise. The shaft portion S₂₂₁ is rotated until the rear cover portion 222 overlaps with a front surface (a lower surface) of the inclination wall portion 213. In this manner, the opening portion OP₂₀ is opened (refer to FIG. 5B). Note that in this state, a distal end portion of the front cover portion 221 is oriented to a lower end of the cooling fan 12 (refer to FIG. 7B).

Closing operation of the front cover portion 221 and the rear cover portion 222 is reverse to the above-described opening operation. In other words, from the state where the opening portion OP₂₀ is opened, the shaft portion S₂₂₁ and the shaft portion S₂₂₂ are rotated clockwise in FIG. 5B by cooperative operation of the actuator 224 and the link mechanisms 223 and 223, and thereby, the front cover portion 221 and the rear cover portion 222 return to the state of FIG. 5A.

The rear duct 30 is attached to a rear surface of the heat exchanger 10. The rear duct 30 guides, to the opening portion OP₂₀, outside air that has passed through the heat exchanger 10. The rear duct 30 includes a rear wall portion 31 and a peripheral wall portion 32 (refer to FIG. 4A and FIG. 4B). The rear wall portion 31 and the peripheral wall portion 32 are integrally formed. In a front view of the rear duct 30, the rear wall portion 31 has a substantially triangular shape. In other words, the rear wall portion 31 has a base extending in the vehicle width direction, and oblique sides extending obliquely upward from a left end and a right end of the base and intersecting with each other on a slightly upper side of an upper end of the cooling fan 12. A dimension (a length of the base) of a lower end portion of the rear wall portion 31 in the vehicle width direction is slightly larger than a dimension of the opening portion OP₂₀ in the vehicle width direction. The peripheral wall portion 32 is constituted of inclination wall portions 321 and 322 formed along the respective oblique sides of the rear wall portion 31. The peripheral wall portion 32 is perpendicular to the rear wall portion 31. A front end of the peripheral wall portion 32 contacts against the rear surface of the heat exchanger 10. Further, lower end portions of the inclination wall portions 321 and 322 of the peripheral wall portion 32 are supported by parts that are in an upper surface of the under cover 20 and that are positioned on respective left and right sides of the opening portion OP₂₀. Furthermore, a rear surface of the lower end portion of the rear wall portion 31 contacts against a front surface of an upper end portion of the vertical wall portion 212 (refer to FIG. 7A and FIG. 7B). The cooling fan 12 is accommodated in the rear duct 30.

In a state where the vehicle cooling device 1 is assembled to the vehicle, the grill shutter 40 is arranged on a rear side of the opening portion OPv of the vehicle V, and adjusts an amount of outside air that is taken from the opening portion OPv into the engine room ER and flows toward the heat exchanger 10. The grill shutter 40 includes a plurality of plate-shaped vanes 41, a frame body 42 that supports the vanes 41, and a driving device 43 that drives the vanes 41 (refer to FIG. 3). Note that the grill shutter 40 corresponds to a flow rate adjusting device of this disclosure.

The vane 41 includes a shaft portion 411 and a plate-shaped portion 412. The shaft portion 411 is formed in a rod shape extending in the vehicle width direction. The plate-shaped portion 412 is formed in a plate shape extending in the vehicle width direction. The shaft portion 411 is provided at a center portion of the plate-shaped portion 412 in a width direction thereof (a direction perpendicular to both of the vehicle width direction and a plate thickness direction thereof).

The frame body 42 includes a base portion 421, an upper pillar portion 422, a left pillar portion 423, and a right pillar portion 424. The base portion 421 extends in the vehicle width direction. The upper pillar portion 422 extends in the vehicle width direction on an upper side of the base portion 421. The left pillar portion 423 and the right pillar portion 424 extend in the vehicle height direction. An upper end portion of the left pillar portion 423 is connected to a left end portion of the upper pillar portion 422, and a lower end portion of the left pillar portion 423 is connected to the base portion 421. Further, an upper end portion of the right pillar portion 424 is connected to a right end portion of the upper pillar portion 422, and a lower end portion of the right pillar portion 424 is connected to the base portion 421. In other words, the frame body 42 includes an opening portion OP₄₀ surrounded by the base portion 421, the upper pillar portion 422, the left pillar portion 423, and the right pillar portion 424.

Further, the frame body 42 includes vertical pillar portions 425 and 426 parallel to the left pillar portion 423 and the right pillar portion 424. The vertical pillar portions 425 and 426 support respective intermediate portions of the upper pillar portion 422 in a longitudinal direction thereof. In other words, an upper end portion of the vertical pillar portion 425 is connected to a part that is in the upper pillar portion 422 and that is positioned on a slightly left side of a center portion of the upper pillar portion 422 in the longitudinal direction, and a lower end portion of the vertical pillar portion 425 is connected to the base portion 421. An upper end portion of the vertical pillar portion 426 is connected to a part that is in the upper pillar portion 422 and that is positioned on a slightly right side of the center portion of the upper pillar portion 422 in the longitudinal direction, and a lower end portion of the vertical pillar portion 426 is connected to the base portion 421. Such vertical pillar portions 425 and 426 divide the opening portion OP₄₀ into three opening portions OP_{40L} and OP_{40C}, and OP_{40R}.

In the opening portions OP_{40L} and OP_{40C}, and OP_{40R}, a plurality of (e.g., four) vanes 41 are arranged at equal intervals in the vehicle height direction, and the shaft part 411 of each vane 41 is rotatably supported by the left pillar portion 423, the right pillar portion 424, and the vertical pillar portions 425 and 426.

The driving device 43 is assembled to the frame body 42. The driving device 43 includes a link mechanism that simultaneously rotates the shaft portions 411 of the vanes 41, and a motor (e.g., a stepping motor) that can drive the link mechanism and thereby adjust a rotational angle of each vane 41. Note that rotational angles of all the vanes 41 (angles of plate thickness directions of the vanes 41 to the vehicle front-rear direction) are the same. Adjusting rotational angles of the vanes 41 can adjust an amount of outside air taken from the opening portion OPv into the engine room ER. For example, when plate thickness directions of the vanes 41 are made to match the vehicle front-rear direction, the opening portion OP₄₀ is closed (refer to FIG. 7A). Accordingly, outside air cannot pass through the grill shutter 40. In other words, outside air is not taken into the engine room ER. In contrast to this, for example, when plate thickness directions of the vanes 41 are made to match the vehicle height direction, the opening portion OP₄₀ is largely opened (refer to FIG. 7B). Accordingly, outside air passes through the grill shutter 40 and flows toward the heat exchanger 10. Note that a dimension of the opening portion OP₄₀ in the vehicle width direction is equivalent to a dimension of the heat exchanger 10 in the vehicle width direction. Meanwhile, a dimension of the opening portion OP₄₀ in the vehicle height direction is smaller than a dimension of the heat exchanger 10 in the vehicle height direction.

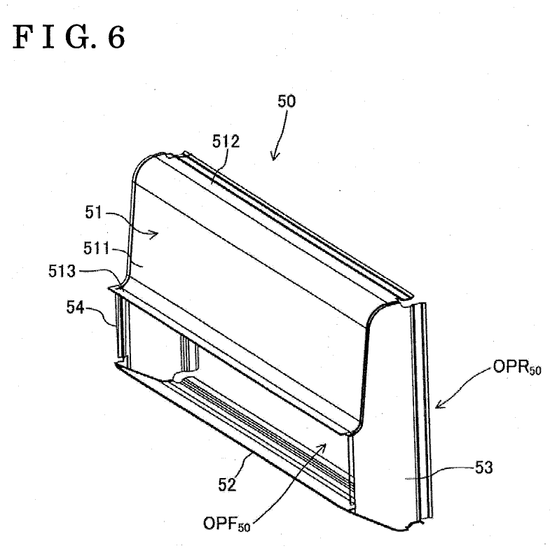

The front duct 50 is arranged between the grill shutter 40 and the heat exchanger 10, and guides, to the heat exchanger 10, outside air that has passed through the grill shutter 40. The front duct 50 includes a front wall portion 51, a base wall portion 52, a left wall portion 53, and a right wall portion 54 (refer to FIG. 4A, FIG. 4B, and FIG. 6). The front wall portion 51, the base wall portion 52, the left wall portion 53, and the right wall portion 54 are joined so as to form the front duct 50. The front wall portion 51 includes a body portion 511 substantially perpendicular to the vehicle front-rear direction, an upper wall portion 512 curving backward from an upper end portion of the body portion 511, and a lower wall portion 513 curving forward from a lower end portion of the body portion 511. In the front duct 50, the bottom wall portion 52 extends in the vehicle width direction on a lower side of the front wall portion 51. The left wall portion 53 extends downward from a left end portion of the front wall portion 51, and is connected to a left end portion of the base wall portion 52. The right wall portion 54 extends downward from a right end portion of the front wall portion 51, and is connected to a right end portion of the base wall portion 52.

A shape and a size of a rear opening portion OPR₅₀ of the front duct 50 are equivalent to a shape and a size of a front surface of the heat exchanger 10. Rear end portions of the upper wall portion 512, the base wall portion 52, the left wall portion 53, and the right wall portion 54 of the front duct 50 are fitted to and fixed to a front portion of an outer peripheral portion of the heat exchanger 10. Meanwhile, a shape and a size of a front opening portion OPF₅₀ of the front duct 50 are equivalent to a shape and a size of the opening portion OP₄₀ of the grill shutter 40. Front end portions of the lower wall portion 513, the left wall portion 53, and the right wall portion 54 of the front duct 50 contact against the upper pillar portion 422, the left pillar portion 423, and the right pillar portion 424 of the grill shutter 40. Further, a front end portion of the base wall portion 52 of the front duct 50 is fixed to an upper surface of a rear portion of the base portion 421 of the grill shutter 40.

In the vehicle cooling device 1 configured as described above, a rear surface side of the heat exchanger 10 is covered with the rear duct 30. The rear duct 30 communicates with the opening portion OP₂₀ of the under cover 20. Different from the vehicle cooling device of PTL 1, regardless of a running state of the vehicle V, rotating the front cover portion 221 and the rear cover portion 222 by using actuator 224 can open and close the opening portion OP₂₀ of the under cover 20. In other words, even in a state where the vehicle V is stopped or running at a low speed, the opening portion OP₂₀ can be closed (refer to FIG. 7A). In other words, a sealed space that covers the rear surface of the heat exchanger 10 can be formed. In this state, even when the vehicle V is running, it is difficult that outside air is taken into the engine room ER, and it is difficult that outside air passes through the heat exchanger 10. In other words, in this state, it is difficult that heat exchange occurs between outside air and cooling water. For this reason, efficiency of warm-up operation can be improved.

Further, in the vehicle cooling device 1, the front surface of the heat exchanger 10 communicates with the grill shutter 40 via the front duct 50. Rotating the vanes 41 by using the driving device 43 can open and close the opening portion OP₄₀ of the grille shutter 40. Closing the opening portion OP₂₀ and closing the opening portion OP₄₀ can form sealed spaces that cover not only the rear surface of the heat exchanger 10 but also the front surface of the heat exchanger 10. In this state, even when the vehicle V is running, outside air hardly passes through the heat exchanger 10. In other words, in this state, heat exchange hardly occurs between outside air and the cooling water. For this reason, efficiency of warm-up operation can be further improved.

Meanwhile, the outside air taken in from the opening portion OPv by opening the opening portion OP₂₀ and the opening portion OP₄₀ passes through the grill shutter 40 (refer to FIG. 7B). The outside air that has passed through the grill shutter 40 is guided to the heat exchanger 10 by the front duct 50. In other words, most of the outside air that has passed through the grill shutter 40 flows toward the front surface of the heat exchanger 10. In other words, the outside air that has passed through the grill shutter 40 can be prevented from being dispersed to surroundings of the heat exchanger 10. When the outside air passes through the heat exchanger 10, heat exchange occurs between the outside air and the cooling water. In other words, heat of the cooling water is dissipated, and a temperature of the outside air surrounding the fins 11 rises. The outside air whose temperature has thus risen is guided to the opening portion OP₂₀ by the cooling fan 12 and the rear duct 30, and is discharged from the opening portion OP₂₀ to a lower side of the vehicle V. In other words, the outside air that has passed through the heat exchanger 10 and whose temperature is relatively high is prevented, by the rear duct 30, from being blown to the engine.

Here, outside air flows rearward along a lower surface of the under cover 20 at the time of running of the vehicle V. As indicated by the arrow in FIG. 5B, the outside air that has flowed rearward along a lower surface of the horizontal wall portion 211 flows rearward while being slightly drawn toward the opening portion OP₂₀ (toward an upper side). Then, the outside air hits the inclination wall portion 213, flows rearward and downward along a lower surface of the inclination wall portion 213, and further flows rearward along a lower surface of the horizontal wall portion 214. In other words, the inclination wall portion 213 guides, rearward, the outside air that has passed the opening portion OP₂₀. In other words, the outside air is prevented from entering an inside of the rear duct 30 from the opened opening portion OP₂₀ so as to be dragged thereto. For this reason, outside air that has passed through the heat exchanger 10 can be made to smoothly flow toward the opening portion OP₂₀. Further, since the outside air smoothly flows (vortex does not easily occur) in the opening portion OP₂₀, a noise (a wind noise) generated in the opening portion OP₂₀ can be reduced.

Further, in implementation of this disclosure, there is no limitation to the above-described embodiment, and various modifications can be made without departing from the object of this disclosure.

For example, in the above-described embodiment, rotating the front cover portion 221 and the rear cover portion 222 opens and closes the opening portion OP₂₀, but an operation mode of the front cover portion 221 and the rear cover portion 222 is not limited to the above-described embodiment. For example, the front cover portion 221 and the rear cover portion 222 may be made to slide in a direction parallel to a side (a short side or a long side) of the opening portion OP₂₀. Note that the cover portion 22 is constituted of the front cover portion 221 and the rear cover portion 222, but may be constituted of one cover portion. For example, the rear cover portion 222 may be omitted, and using only the front cover portion 221 (i.e., only the cover portion that rotates or moves forward) may open and close the opening portion OP₂₀.

Further, for example, the grill shutter 40 of the above-described embodiment may be omitted. In this case, the sealed space is not formed on the front side of the heat exchanger 10, but closing the opening portion OP₂₀ can form the sealed space that covers the rear surface of the heat exchanger 10. In other words, a path for discharging outside air to an outside of the vehicle does not exist on a side of the rear surface of the heat exchanger 10. In this state, even when the vehicle V is running, it is difficult that outside air is taken into the front duct 50, and it is difficult that outside air passes through the heat exchanger 10. In other words, in this state, it is difficult that heat exchange occurs between outside air and the cooling water. Accordingly, efficiency of warm-up operation can be improved.

Note that instead of being applied to a vehicle driven by an engine, this disclosure may be applied to a vehicle driven by an electric motor.

A vehicle cooling device according to this disclosure includes a heat exchanger, an under cover, and a rear duct. The heat exchanger is arranged so as to be exposed to outside air that is taken into an inside of a vehicle from a front side of the vehicle and that flows backward. The under cover constitutes a lower wall surface of a front end portion of the vehicle. The under cover includes a cover portion that can open and close an opening portion positioned on a rear side of the heat exchanger, and a driving device that drives opening and closing of the cover portion. The rear duct is provided on a rear side of the heat exchanger, and guides, to the opening portion of the under cover, outside air that passes through the heat exchanger.

In the vehicle cooling device configured as described above, a rear surface side of the heat exchanger is covered with the rear duct. The rear duct communicates with the opening portion of the under cover. As being different from the vehicle cooling device of PTL 1, regardless of a running state of the vehicle, driving the cover portion by using the driving device can open and close the opening portion of the under cover. Specifically, even in a state where the vehicle is stopped or running at a low speed, the opening portion can be closed. In other words, a sealed space that covers a rear surface of the heat exchanger can be formed. In this state, even when the vehicle is running, it is difficult that outside air passes through the heat exchanger. In other words, in this state, it is difficult that heat exchange occurs between outside air and cooling water. For this reason, efficiency of warm-up operation can be improved.

The vehicle cooling device according to one aspect of this disclosure may include a flow rate adjusting device being provided on a front side of the heat exchanger and adjusting a flow rate of outside air taken into the inside of the vehicle from the front side of the vehicle.

In the above-described one aspect of the vehicle cooling device, when an amount of outside air flowing toward the heat exchanger is set to be small by using the flow rate adjusting device, it is difficult that heat exchange occurs between outside air and cooling water in the heat exchanger. Accordingly, efficiency of warm-up operation can be further improved.

The vehicle cooling device according to another aspect of this disclosure may include a front duct being provided between the flow rate adjusting device and the heat exchanger and guiding, to a front surface of the heat exchanger, outside air that passes through the flow rate adjusting device.

In the above-described aspect of the vehicle cooling device, the front surface of the heat exchanger communicates with the flow rate adjusting device via the front duct. Thereby, closing the opening portion of the under cover, and blocking, by using the flow rate adjusting device, outside air to be taken into the inside of the vehicle can seal the front surface and the rear surface of the heat exchanger. In other words, it is possible to form the sealed space surrounded by the rear surface of the heat exchanger, the rear duct, and the under cover, and to form a sealed space surrounded by the front surface of the heat exchanger, the front duct, and the flow rate adjusting device as well. Thereby, efficiency of warm-up operation can be further improved.

Note that the vehicle cooling device according to another aspect of this disclosure, the cover portion may include a front cover portion rotatable around a shaft portion extending in a vehicle width direction at a front end portion of the opening portion, and in a state where the opening portion is opened, a distal end portion of the front cover portion may be oriented to a lower end of the heat exchanger.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A vehicle cooling device comprising:
a heat exchanger arranged so as to be exposed to outside air that is taken into an inside of a vehicle from a front side of the vehicle and that flows backward;
an under cover constituting a lower wall surface of the vehicle, and including a cover portion that can open and close an opening portion positioned on a rear side of the heat exchanger, and a driving device that drives opening and closing of the cover portion; and
a rear duct being provided on a rear side of the heat exchanger and guiding, to the opening portion of the under cover, outside air that passes through the heat exchanger.

2. The vehicle cooling device according to claim 1, further comprising a flow rate adjusting device being provided on a front side of the heat exchanger and adjusting a flow rate of outside air taken into the inside of the vehicle from the front side of the vehicle.

3. The vehicle cooling device according to claim 2, further comprising a front duct being provided between the flow rate adjusting device and the heat exchanger and guiding, to a front surface of the heat exchanger, outside air that passes through the flow rate adjusting device.

4. The vehicle cooling device according to claim 1, wherein
the cover portion includes a front cover portion rotatable around a shaft portion extending in a vehicle width direction at a front end portion of the opening portion, and,
in a state where the opening portion is opened, a distal end portion of the front cover portion is oriented to a lower end of the heat exchanger.

5. The vehicle cooling device according to claim 2, wherein
the cover portion includes a front cover portion rotatable around a shaft portion extending in a vehicle width direction at a front end portion of the opening portion, and,
in a state where the opening portion is opened, a distal end portion of the front cover portion is oriented to a lower end of the heat exchanger.

6. The vehicle cooling device according to claim 3, wherein
the cover portion includes a front cover portion rotatable around a shaft portion extending in a vehicle width direction at a front end portion of the opening portion, and,
in a state where the opening portion is opened, a distal end portion of the front cover portion is oriented to a lower end of the heat exchanger.
